(19) United States
(12) Patent Application Publication
(10) Pub. No.: US 2013/0143142 A1
(43) Pub. Date: Jun. 6, 2013

(54) Composite Solid Oxide Fuel Cell Electrolyte

(71) Applicants: Mingfei LIU, Atlanta, TX (US); Meilin LIU, Alpharetta, GA (US); Ting HE, Bartlesville, OK (US)

(72) Inventors: Mingfei LIU, Atlanta, TX (US); Meilin LIU, Alpharetta, GA (US); Ting HE, Bartlesville, OK (US)

(73) Assignees: GEORGIA TECH RESEARCH CORPORATION, Atlanta, GA (US); PHILLIPS 66 COMPANY, Houston, TX (US)

(21) Appl. No.: 13/596,787

(22) Filed: Aug. 28, 2012

Related U.S. Application Data
(60) Provisional application No. 61/540,529, filed on Sep. 28, 2011.

(51) Int. Cl. H01M 8/14; F27D 19/00

(52) U.S. Cl. 429/478; 429/535; 432/1

(57) ABSTRACT

The present invention discloses a novel BZCYYb-carbonate composite electrolyte and method for making the same. The BZCYYb is porous, and the lithium-potassium carbonate is infiltrated or entrained within the pores of the BZCYYb to have better conductivity at the phase boundaries.

### PRIORITY CLAIM

This invention claims priority to 61/540,529, filed Sep. 28, 2011, and expressly incorporated by reference herein.

### FIELD OF THE INVENTION

The invention relates to a composite electrolyte material for a solid oxide fuel cell, and particularly to a BZCYYb-carbonate composite electrolyte that has BZCYYb as the backbone and lithium-potassium carbonate as the secondary phase.

### BACKGROUND OF THE INVENTION

The demand for clean, secure, and renewable energy has stimulated great interest in fuel cells. A fuel cell is a device that converts chemical energy from a fuel into electricity through electrochemical reactions involving oxygen or another oxidizing agent. Fuel cells are different from batteries in that they require a constant source of fuel and oxygen to run, but they can produce electricity continually, so long as these inputs are supplied.

There are many types of fuel cells, but they all consist of an anode (negative side), a cathode (positive side) and an electrolyte that allows charges to move between the two sides of the fuel cell. Electrons are drawn from the anode to the cathode through an external circuit, producing direct current electricity. The main difference between the various types of fuel cells is the electrolyte. Thus, fuel cells are classified by the type of electrolyte they use. There are many different types of fuel cells, including molten carbonate fuel cells (MCFC), phosphoric acid fuel cells (PAFC), alkaline fuel cells (AFC), polymer electrolyte membrane fuel cells (PEMFC), and many more.

Solid Oxide Fuel Cells (SOFCs) are a particular type of fuel cell that uses a solid oxide or ceramic as the electrolyte of a cell. SOFCs are also known as high temperature fuel cells because the solid phase electrolytes usually do not show acceptable conductivity until they reach a high temperature of about 800-1000° C. The solid oxide fuel cell is usually made of three ceramic layers (hence the name): a porous cathode, a porous anode, and an electrolyte. SOFCs can have a fourth layer, called an interconnect layer, used to stack multiple fuel cells together. Hundreds of the single cells are typically connected in series or parallel to form what most people refer to as an “SOFC stack.” A basic SOFC is shown in FIG. 1, which illustrates a single cell in FIG. 1A and a stack of cells in FIG. 1B.

One of the important benefits of SOFCs is that SOFC systems can run on fuels other than pure hydrogen gas. This is because the high operating temperatures allow SOFCs to internally reform light hydrocarbons such as methane (natural gas), propane and butane to the H₂ and CO needed for the fuel cell reactions. Heavier hydrocarbons including gasoline, diesel, jet fuel and biofuels can also serve as fuels in a SOFC system, but an upstream external reformer is usually required.

Among the many types of fuel cells, the SOFCs represent the cleanest, most efficient, and versatile energy conversion system, offering the prospect of efficient and cost effective utilization of hydrocarbon fuels, coal gas, biomass, and other renewable fuels. However, SOFCs must be economically competitive to be commercially viable, and high operating temperatures and expensive materials contribute significantly to cost.

One approach to cost reduction is to drastically reduce the operating temperature from high temperatures to intermediate temperatures, usually about 400-700° C., thereby allowing the use of less expensive materials in the components and improving system longevity. Unfortunately, lowering the operating temperature also lowers the fuel cell performance, as the electrolyte and electrode materials become less conductive and less catalytically active.

Long-term performance of SOFCs also degrades due to poisoning of the cathode by chromium from interconnect layers, deactivation of the conventional anode by carbon deposition, and poisoning by contaminants (e.g., sulfur) in the fuel gas.

Oxygen ion conductors are the conventional conductors for electrolyte use in SOFC (e.g., FIG. 1). However, both proton and mixed ion conductors are available today for SOFC use. The reaction chemistry and examples of oxygen-ion conductors and proton conductors are shown in Table 1:

TABLE 1
Oxygen ion and proton conductors

| Type of conductor | Oxygen ion | Proton |
|---|---|---|
| Anode reaction | H₂ + O²⁻ → H₂O + 2e−/ | H₂ → 2H⁺ + 2e− |
| | CO + O²⁻ → CO2 + 2e− | |
| Cathode reaction | O₂ + 4e− → 2O²⁻ | 2H⁺ + 2e− + 1/2 O₂ → H₂O |
| Overall reaction | 2H₂ + O₂ → 2H₂O/ | 2H₂ + O₂ → 2H₂O |
| | 2CO + O₂→ 2CO₂ | |
| Advantages | H₂O, CO₂ and high temperatures at | No fuel dilution |
| | anode (fuel side) facilitates reforming | Intermediate operating temperature |
| | of hydrocarbon fuels to H₂ and CO | |
| Disadvantages | High operating temperature degrades | Reforming at anode (fuel side) lost |
| | system components and adds to cost | |
| | H₂O formed at anode dilutes fuel | |
| Examples | yttria-stabilized zirconia (YSZ) | Yttria-doped BaZrO₃ (BYZ) |
| | samarium doped ceria (SDC) | calcium-doped lanthanum niobate |
| | gadolinium doped ceria (GDC) | (LCaNb) |
| | scandia stabilized zirconia (ScSZ) | Y-doped BaCeO₃ (BCY) |
| | strontium and magnesium doped | barium-zirconium-cerium-yttrium |
| | lanthanum gallate (LSGM) | (BZCY) |
| | | barium-zirconium-cerium-yttrium |
| | | ytterbium (BZCYYb) |

The third option is to tailor the proton and oxygen ion transference number of the mixed ion conductor, allowing CO₂ to form on the fuel side while allowing most of the H₂O to form on the air side. The class of mixed proton and oxygen ion conductors holds great potential for a new generation of low temperature SOFCs. However, to date, the ideal mixed ionic conductor has not been found.

Thus, in order to make SOFCs fully fuel-flexible and cost-effective power systems, the issues of anode tolerance to coking and sulfur poisoning, slow ionic conduction in the electrolyte, and sluggish kinetics at the cathode need to be addressed. In a broader scientific context, the chemical and electrochemical mechanisms that lead to both of these issues and the phenomena that could prevent them should be investigated in order to best optimize the materials and microstructure of SOFCs for excellent performance and stability.

Composite electrolyte materials have been proposed to solve the above-mentioned problems, especially in lowering the operating temperature of the SOFC while maintaining the same or even higher ion conductivity and current density. U.S. Pat. No. 7,527,761 discloses a two-phase composite electrolyte comprised of YSZ and a metal oxide that can lower the manufacturing cost. U.S. Pat. No. 7,485,385 discloses a similar composite electrolyte for inexpensive fabrication. However, these patents do not discuss the enhanced conductivity of the electrolyte. U.S. Pat. No. 7,045,237 proposes a two-layered composite electrolyte that comprises one layer of ceria on top of another layer of YSZ, which composite is supposed to provide higher ionic conductivity, but no hard data concerning increased conductivity is provided in the patent. U.S. Pat. No. 7,014,942 proposes a porous electrolyte material with copper dispersed within the pores of the porous electrolyte. The porous electrolyte used in that patent is YSZ, which has considerable low conductivity at temperatures lower than 700° C. when compared to other materials such as GDC, BZCY or BZCYYb, shown in FIG. 2. Therefore, the copper-dispersed YSZ is not a viable solution to the electrolyte problems.

U.S. Pat. No. 7,842,200 discloses a composite anode material that comprises YSZ and a catalytically active metal, in which the composite powder particles are in the nanometer range. However, as discussed above, YSZ is probably not the best material for use as an electrolyte. Furthermore, this patent is mainly about an anode having catalytic activity to facilitate in-situ reforming processes.

U.S. Pat. No. 7,618,731 discloses a ceramic-ceramic nanocomposite electrolyte that has enhanced conductivity, in which the nanocomposite electrolyte has a YSZ/SSZ ceramic mixed with a dopant material selected from Al₂O₃, TiO₂, MgO, BN and Si₃N₄. The conductivity of said electrolyte can have 0.10 to 0.50 S/cm at 600 to 950° C.

In another branch of fuel cells, called the molten carbonate fuel cells or MCFCs, lithium-potassium carbonate is used as the electrolyte. MCFCs are designed to operate at temperatures comparable with SOFCs, i.e. higher than 650° C. The lithium-potassium carbonate salt at these temperatures will melt, and charged molecules can diffuse from one electrode to another through the molten state electrolyte. The carbonate electrolyte is stored in the pores of the porous electrolyte matrix as well as the electrodes, and the electrolyte melts during cell operation and is redistributed among the matrix and electrodes due to capillary forces of the pores.

MCFCs possess the advantage of high fuel-to-electricity efficiencies (approaching 50%), and overall thermal efficiency as high as 85%. Conventional MCFCs typically use an eutectic carbonate mixture of 62 mole % of lithium carbonate and 38 mole % of potassium carbonate. However, due to the fact that in MCFC cell operation the electrolyte is consumed by corrosive reactions with cell components, the liquid electrolyte migrates within the cell stack. Because lithium and potassium ions migrate at a different rate, there will be variations of lithium-to-potassium molar ratio within the stack. This variation causes problems inside the MCFCs, such as the varying conductivity and melting point of the electrolyte that impacts the cells' performance. The MCFC electrode also reacts with the carbonate electrolyte, resulting in a short lifetime. In addition, the power density of MCFCs are very low compared to SOFCs.

Given the fact that BZCYYb can have high ionic conductivity at lower temperatures, it is advantageous to increase the ionic conductivity even higher by including a substance that can wet the BZCYYb grain boundaries, which in turn influences the conducting mechanism within the electrolyte.

Therefore, there is the need for an electrolyte material that can provide higher ion conductivity at lower temperatures, especially at temperatures lower than about 650° C., so as to allow wider choice of materials in SOFC design that may in turn reduce the fabrication cost and improves the cell reliability, efficiency and overall performance.

### SUMMARY OF THE INVENTION

The present invention discloses a novel composite electrolyte material to be used in SOFCs, wherein BZCYYb serves as the porous electrolyte backbone and a secondary phase of carbonate infiltrated within the pores can enhance the conductivity at the grain boundaries between BZCYYb and the carbonate. Despite the rather high ion conductivity of BZCYYb as compared to other known electrolytes for SOFCs, the liquid state of molten carbonate during cell operation supposedly can provide even more seamless transportation of charged molecules between electrodes with less ohmnic loss.

Although not yet tested, it is likely that the above invention can be applied to any of the other known proton based electrolytes, especially the related electrolyte containing some of the same elements. Thus, the invention is expected to be applicable to BYZ, BZCY, and may also be applicable to LCaNb.

The present invention also provides a method for preparing the novel composite electrolyte material. The method comprises the steps of first preparing a lithium-potassium carbonate, preferably by solid state reaction, followed by mixing the lithium potassium carbonate with a porous BZCYYb powder. The mixture is then heated to a temperature that is preferably higher than the melting point of the lithium-potassium carbonate (but not the BZCYYb) so that the molten carbonate salt can infiltrate or penetrate the pores of the BZCYYb. The mixture is then quenched in air, and preferably quenched to room temperature, to yield the BZCYYb-carbonate composite electrolyte. In a preferred embodiment, the quenched mixture is ground again to reach even better homogeneity.

The present invention further provides a composite electrolyte prepared by the above-mentioned method, with a conductivity of at least 0.1 S/cm at 550° C. Additionally, the so-prepared composite electrolyte has an open circuit value (OCV) value higher than 1.07 V at temperatures between 375 and 525° C.

The present invention also provides a solid oxide fuel cell that comprises a composite electrolyte having a porous BZCYYb based electrolyte backbone and a carbonate secondary phase entrained in the pores of the porous BZCYYb.

The carbonate used in the present invention is not limited, as long as the resulting composite electrolyte remains solid at its operating temperature and the ionic conductivity and/or the power density are higher than BZCYYb alone. In one embodiment, the carbonate is lithium-potassium carbonate represented by (Li₁₋ₓKₓ)₂CO₃, wherein 0<x<1. In another embodiment, the carbonate is (Li_{0.62}K_{0.38})₂CO₃.

As used herein, “BZCYYb” represents BaZr_{1-x-y-z}CeₓY_{y}Yb_{z}O_{3-δ}, wherein x, y, and z are dopant levels between 0 to 1 and x+y+z<1 and δ is the oxygen ion deficit.

As used herein, “lithium-potassium carbonate” represents (Li₁₋ₓKₓ)₂CO₃, wherein 0<x<1, and preferably (Li_{0.62}K_{0.38})₂CO₃. However, other carbonate compositions are also viable without deviating from the spirit of the present invention.

In one embodiment, the carbonate may comprise 50-75% lithium and 25-50% potassium. In another embodiment, a 72% lithium/28% potassium carbonate is used. In addition, other kinds of carbonate may be used. For example, (Li₁₋ₓNaₓ)₂CO₃ may also be used as the carbonate in the present invention. Furthermore, the molar ratio between lithium and sodium may vary, as long as the ionic conductivity of the electrolyte can be improved.

As used herein, the term “porous” refers to the structure of the resulting material having multiple pores in the nanometer range.

As used herein, the term “backbone” refers to the mechanical structure of a primary material on which a secondary material can be deposited, dispersed or infiltrated.

As used herein, the term “secondary phase” refers to the phase of the carbonate infiltrated in the pores of the porous BCZYYb backbone.

The following abbreviations are used herein:

| | |
|---|---|
| LSGM | La₁₋ₓSrₓGa_{1-y}Mg_{y}O_{3-δ} |
| SOFC | Solid oxide fuel cell |
| YSZ | Yttria-stabilized zirconia |
| SSZ | Scandia-stabilized zirconia |
| BCY | Y-doped BaCeO3 |
| LCaNb | Calcium-doped lanthanum niobate |
| BYZ | Y-doped BaZrO3 |
| BZCYYb | BaZr_{1-x-y-z}CeₓY_{y}Yb_{z}O_{3-δ} |
| SDC | Samarium-doped ceria |
| GDC | Gadolinium-doped ceria |
| BZCY | BaZr_{1-x-y}CeₓY_{y}O_{3-δ} |
| MCFC | Molten carbonate fuel cell |
| OCV | Open circuit voltage |

Where x, y, z are dopant amounts and together must be less than 1, and delta is the oxygen ion deficit.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

### BRIEF DESCRIPTION OF THE DRAWINGS

FIG. 1A-B. FIG. 1A is diagram of a typical SOFC cell and 1B is a stack of cells.

FIG. 2 compares the ion conductivity of different electrolytes at temperatures between 400 and 750° C.

FIG. 3 compares the conductivities of the composite BZCYYb-carbonate electrolyte of the present invention with pure BZCYYb at various temperatures.

FIG. 4 shows the power density of the composite BZCYYb-carbonate electrolyte of the present invention between 375 and 525° C.

FIG. 5 shows both the maximum power density and the open circuit voltage of the composite BZCYYb-carbonate electrolyte of the present invention between 375 and 525° C.

FIG. 6 is an SEM photo showing a composite electrolyte interposed between a cathode and an anode.

FIG. 7 is an SEM photo showing the composite electrolyte having a smooth boundary between BZCYYb and carbonate.

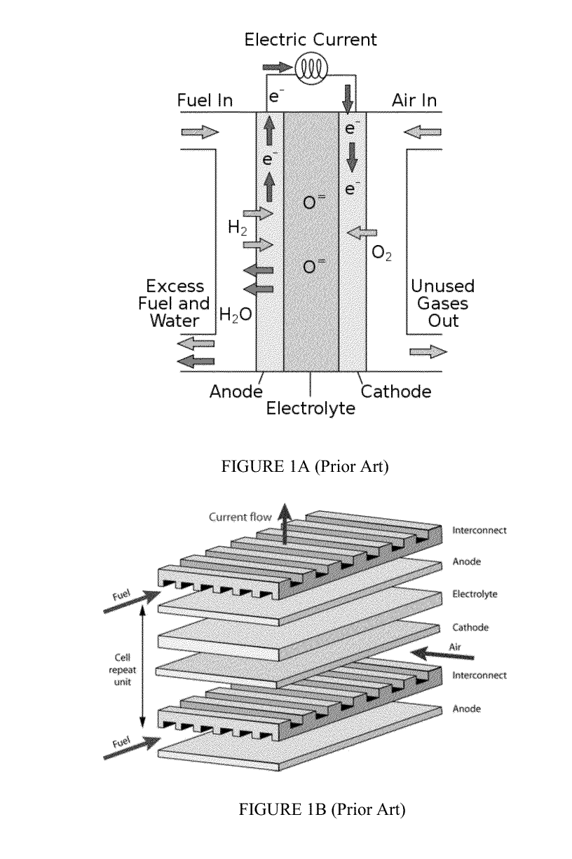

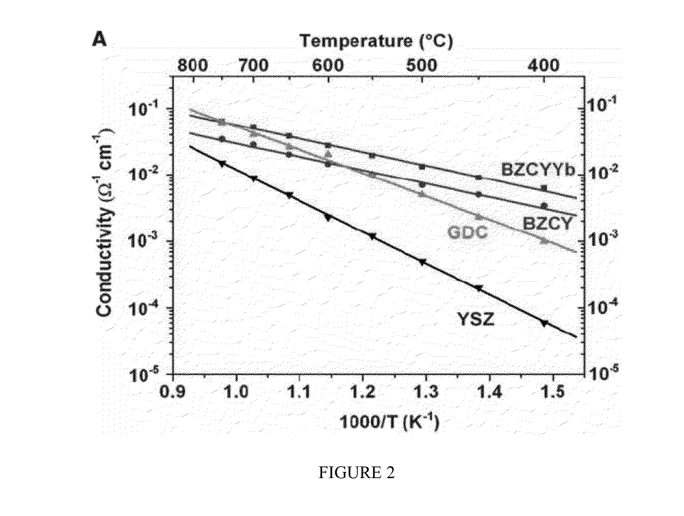

### DESCRIPTION OF EMBODIMENTS OF THE INVENTION

The invention provides a novel composite electrolyte material, method for making the same, as well as fuel cells containing same and uses for such fuel cells. Specifically, the novel composite electrolyte of the present invention comprises porous BZCYYb as the backbone and carbonate as the secondary phase within the pores of BZCYYb so as to provide better ion conductivity at the phase boundaries.

The weight ratio of BZCYYb in the composite electrolyte may vary, as long as the composite electrolyte can reach higher conductivity as well as current density as compared to non-composite electrolyte. In one embodiment, the weight ratio of BZCYYb in the composite electrolyte ranges from 9:1 to 1:1, but more preferably ranges from 50-90% or 70-80%. In another embodiment, the weight ratio of BZCYYb is about 75%.

The weight percentage of carbonate in the composite electrolyte also may vary, as long as the composite electrolyte can maintain physical integrity during operation. In one embodiment, the weight percentage of carbonate in the composite electrolyte ranges from 10 to 50wt %. In another embodiment, the weight percentage of carbonate in the composite electrolyte ranges from 20 to 30wt %, in yet another embodiment, the carbonate is about 25%.

The following discussions are illustrative only, and are not intended to unduly limit the scope of the invention.

### Preparing Lithium-Potassium Carbonate

Stoichiometrical amount of Li₂CO₃ and K₂CO₃ were mixed in the weight proportion of 45.8:52.5 and milled in a vibratory mill for 1 hour. The mixture was then heated to 600° C. for 2 hours. The heated mixture was then quenched in air to the room temperature and ground. The resulting lithium-potassium carbonate was used later in the preparation of composite electrolyte with BZCYYb.

### Preparing BZCYYb

The BZCYYb powder was prepared herein by solid-state reaction, but other methods could also be used. Stoichometric amount of high-purity barium carbonate, zirconium oxide, cerium oxide, ytterbium oxide and yttrium oxide powders (all from Sigma-Aldrich® Chemicals) were mixed by ball milling in ethanol (or other easily evaporated solvent) for 24 h, followed by drying at 80° C. for overnight and calcinations at 1100° C. in air for 10 h. The calcinated powder was ball milled again, followed by another calcination at 1100° C. in air for 10 h to produce single phase BZCYYb.

### Preparing Composite

The resulted BZCYYb powder and the carbonate obtained above were mixed at weight ratio of 75:25 and thoroughly ground again for one hour. The mixture was then heated to 680° C. for 60 minutes until only the carbonate melted and wet the BZCYYb grain boundaries in the mixture. Next, it was quenched (i.e. fast cooling) in air to room temperature. The quenched mixture was ground again to get the composite electrolyte powder.

The as prepared composite BZCYYb-carbonate can be seen in FIG. 7. As shown in FIG. 7, there is no obvious boundary between BZCYYb and carbonate and, consequently, the composite electrolyte can theoretically have much better ionic conductivity when used in high temperature SOFC operation.

### Composite Testing

To test the electrical property of the material as an electrolyte for SOFCs, the as prepared BZCYYb-carbonate composite was dry-pressed at 275 MPa to form 10 mm-diameter pellets, which were subsequently hardened at 600° C. for one hour. Silver paste and silver wires were applied to both sides of the electrolyte for a conductivity test.

Anode supported cells with configuration of NiO-composite/composite electrolyte/Ag₂O-composite were prepared by the co-pressing and co-firing process to obtain full cells. The whole cell was mounted on an alumina supporting tube for fuel cell testing with humidified hydrogen (3% H₂O) as fuel and ambient air as oxidant. The power output performances and the long-term electrochemical performances of test cells were performed using an ARBIN INSTRUMENTS™ fuel cell testing system (MSTAT).

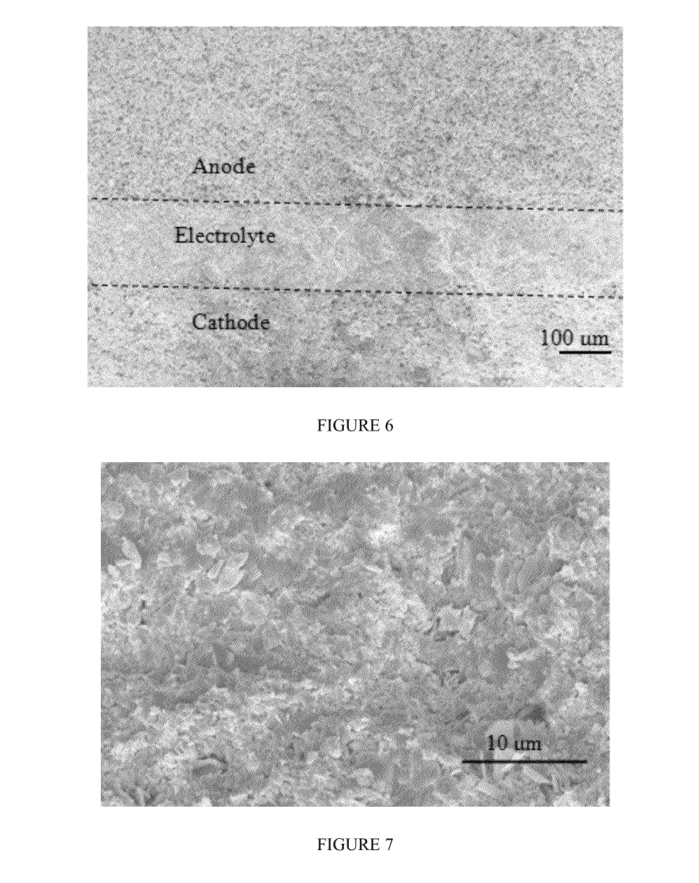

The resulting anode/electrolyte/cathode structure is shown in FIG. 6, which is a SEM photo of the cross-sectional view of the structure. As can be seen, porous anode/cathode are separated by a dense electrolyte membrane. In this photo the electrolyte membrane has a thickness of approximately 120 μm. It is expected that reduction in the thickness of the electrolyte membrane can further improve the ionic conductivity of the electrolyte.

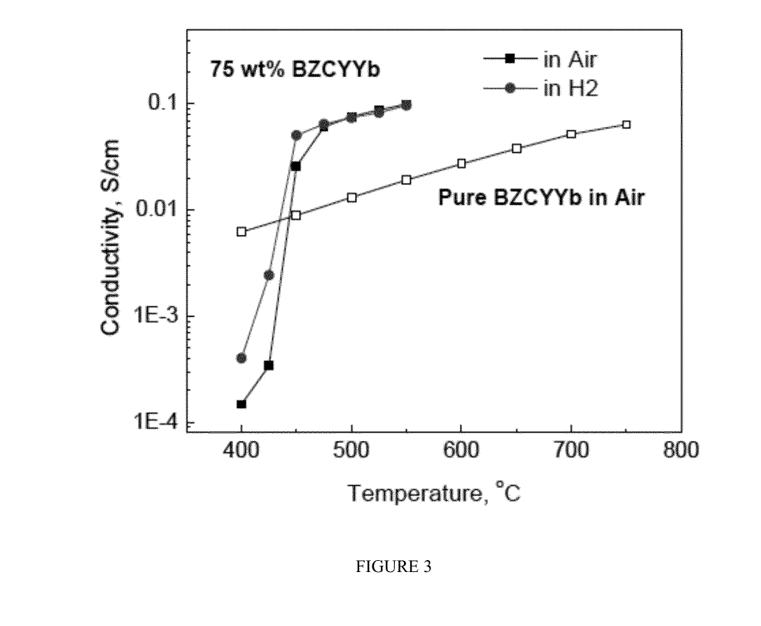

FIG. 3 shows the temperature dependence of the conductivity measured in air and hydrogen for a BZCYYb-carbonate composite electrolyte and BZCYYb sintered at 1550° C. At temperatures above 500° C., the conductivity of the composite electrolyte was much higher than pure BZCYYb. It reached 0.1 S/cm at 550° C., about one order of magnitude higher than pure BZCYYb electrolyte (˜0.019 S/cm). Although liquid (Li_{0.62}K_{0.38})₂CO₃ has higher reported conductivity, others also reported that the effective conductivity of liquid (Li_{0.62}K_{0.38})₂CO₃ in a non-conductive porous matrix is much lower.

The mechanism of the conductivity enhancement of the BZCYYb by mixing with the carbonate is still not clearly understood. One hypothesis is that the enhanced conductivity is caused by the interface between BZCYYb and the carbonate, which promotes fast ionic transportation. It is noted that a sharp discontinuity in the plot for carbonate composites occurs at 475° C., which is slightly lower than the melting point of (Li_{0.62}K_{0.38})₂CO₃ at around 490° C. This suggests that the interface between BZCYYb and carbonate may have influence on the melting temperature of the carbonate. In addition, this means higher ionic conductivity may be achieved at lower temperature because of the lower melting point of the carbonate.

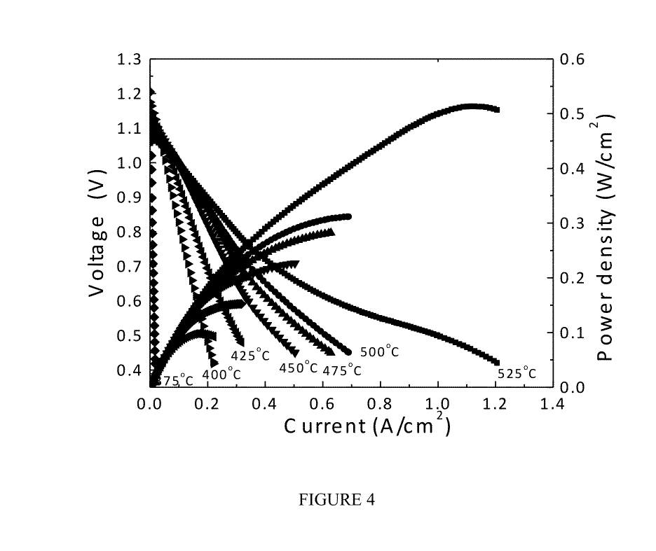

FIG. 4 shows the current-voltage characteristic and the corresponding power density of single cell with BZCYYb-carbonate composite electrolyte tested in the temperature range of 375 to 525° C. The open circuit voltage (OCV) values of the cell were higher than 1.07 V at different temperatures, indicating that the composite electrolyte shows pure ionic conductivity and a dense electrolyte membrane was formed in the co-pressing and co-firing process. This result indicate that the fuel cell can be operated at or below 525° C. to generate power comparable to that of conventional SOFCs at temperatures higher than 600° C.

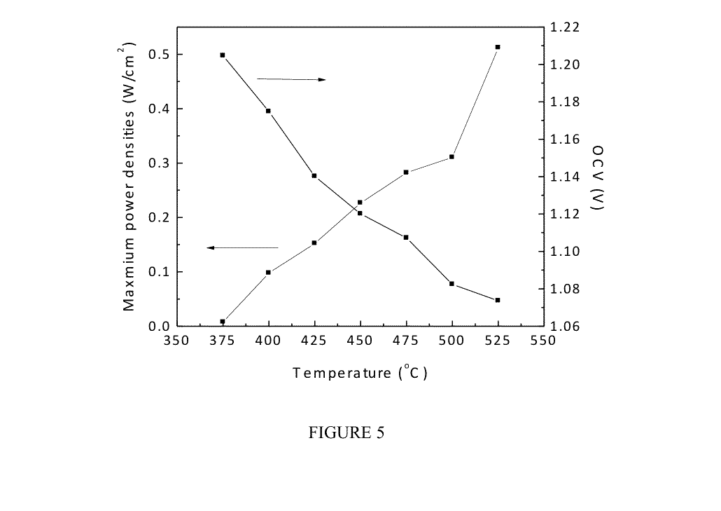

FIG. 5 shows maximum power densities of approximately 0.3 W/cm² and 0.5 W/cm² were achieved at 500° C. and 525° C., respectively. Further research is being conducted to explore the less-than-expected power densities. Nevertheless, FIG. 5 shows that the present invention still provides comparable peak power density with BZCYYb alone at a much lower temperature (BZCYYb is reported to have peak power density of 0.53 W/cm² at 600° C.). Further, we anticipate that optimization of ingredient ratios and SOFC design will further improve performance.

The following references are incorporated by reference in their entirety.
1. Tanimoto, K., Y. Miyazaki, M. Yanagida, S. Tanase, T. Kojima, N. Ohtori, H. Okuyama, and T. Kodama, Cell Performance of Molten-Carbonate Fuel-Cell with Alkali and Alkaline-Earth Carbonate Mixtures. Journal Of Power Sources, 1992. 39(3): p. 285-297.
2. Lagergren, C. and G. Lindbergh, Experimental determination of effective conductivities in porous molten carbonate fuel cell electrodes. Electrochimica Acta, 1998. 44(2-3): p. 503-511.
3. Chen et al., Anode-supported tubular SOFCs based on BaZr_{0.1}Ce_{0.7}Y_{0.1}Yb_{0.1}O_{3-δ} electrolyte fabricated by dip coating. Electrochemistry Communications 13 (2011): pp. 615-618.
4. Yang, L. et al. Enhanced Sulfur and Coking Tolerance of a Mixed Ion Conductor for SOFCs: BaZr_{0.1}Ce_{0.7}Y_{0.2-x}YbₓO_{3-delta}. Science 326, 126-129, doi:DOI 10.1126/science.1174811 (2009)
5. U.S. Pat. No. 7,485,385
6. U.S. Pat. No. 7,045,237
7. U.S. Pat. No. 7,014,942
8. U.S. Pat. No. 7,842,200
9. U.S. Pat. No. 7,618,731
10. U.S. Pat. No. 7,527,761

What is claimed is:

1. A composite solid electrolyte having a porous BZCYYb electrolyte backbone and a carbonate secondary phase entrained in the pores of the porous BZCYYb electrolyte backbone.

2. The composite electrolyte of claim 1, wherein the carbonate is lithium-potassium carbonate (Li₁₋ₓKₓ)₂CO₃, wherein 0<x<1.

3. The composite electrolyte of claim 2, wherein the lithium-potassium carbonate is (Li_{0.62}K_{0.38})₂CO₃.

4. The composite electrolyte of claim 1, wherein the carbonate is lithium-sodium carbonate (Li₁₋ₓNaₓ)₂CO₃, wherein 0<x<1.

5. The composite electrolyte of claim 1, wherein the composite electrolyte has a conductivity of at least 0.1 S/cm at 550° C.

6. The composite electrolyte of claim 1, wherein the composite electrolyte has an open circuit voltage value higher than 1.07 V between 375 and 525° C.

7. A method of making a composite electrolyte having a porous BZCYYb electrolyte backbone and a carbonate secondary phase, comprising the steps of:
a) obtaining a lithium-potassium carbonate;
b) obtaining a pure phase BZCYYb;
c) mixing said lithium-potassium carbonate with said BZCYYb to form a mixture;
c) heating said mixture to melt the lithium-potassium carbonate; and
d) quenching the melted lithium-potassium carbonate and BZCYYb mixture in air.

8. The method of claim 7, further comprising the step:
e) grinding the quenched mixture.

9. The method of claim 7, wherein the lithium-potassium carbonate is (Li₁₋ₓKₓ)₂CO₃, wherein 0<x<1.

10. The method of claim 9, wherein the lithium-potassium carbonate is (Li_{0.62}K_{0.38})₂CO₃.

11. The method of claim 9, wherein the lithium-potassium carbonate is (Li_{0.72}K_{0.28})₂CO₃.

12. The method of claim 9, wherein the weight ratio of BZCYYb to the lithium-potassium carbonate is from 9:1 to 1:1 weight percent.

13. The method of claim 9, wherein the weight percentage of the lithium-potassium carbonate in the composite electrolyte is about 10 wt % to 50 wt %.

14. The method of claim 13, wherein the weight percentage of the lithium-potassium carbonate in the composite electrolyte is about 20 wt % to 30 wt %.

15. The method of claim 9, wherein in step a) the lithium-potassium carbonate is prepared by mixing Li₂CO₃ and K₂CO₃ and heating the mixture to 600° C.

16. The method of claim 5, wherein in step c) the heating is carried out by heating the mixture to at least 650° C. for at least one hour.

17. A composite electrolyte prepared by the method of claim 5, wherein the composite electrolyte has a conductivity of at least 0.1 S/cm at 550° C.

18. The composite electrolyte of claim 17, wherein the composite electrolyte has an OCV value higher than 1.07V between 375 and 525° C.

19. A solid oxide fuel cell comprising an anode adjacent an electrolyte adjacent a cathode, wherein said electrolyte is a composite electrolyte having a porous BZCYYb backbone and a carbonate secondary phase in the pores of the porous BZCYYb backbone.

20. The solid oxide fuel cell of claim 19, wherein the carbonate in the composite electrolyte is lithium-potassium carbonate (Li₁₋ₓKₓ)₂CO₃, wherein 0<x<1.

21. The solid oxide fuel cell of claim 20, wherein the lithium-potassium carbonate is (Li_{0.62}K_{0.38})₂CO₃.

22. The method of claim 20, wherein the lithium-potassium carbonate is (Li_{0.72}K_{0.28})₂CO₃.

23. The solid oxide fuel cell of claim 19, wherein the carbonate in the composite electrolyte is lithium-sodium carbonate (Li₁₋ₓNaₓ)₂CO₃, wherein 0<x<1.

24. The solid oxide fuel cell of claim 19, wherein the composite electrolyte has a conductivity of at least 0.1 S/cm at 550° C.

25. The solid oxide fuel cell of claim 19, wherein the composite electrolyte has an open circuit voltage value higher than 1.07 V between 375 and 525° C.

26. A composite solid electrolyte having a porous BZCYYb electrolyte backbone and a lithium-sodium carbonate secondary phase entrained in the pores of the porous BZCYYb electrolyte backbone, wherein the lithium-sodium carbonate is 20-30% of the weight of the composite electrolyte.

27. A composite solid electrolyte having a porous proton type electrolyte backbone and a carbonate secondary phase entrained in the pores of the porous proton type electrolyte backbone, wherein the lithium-sodium carbonate is 20-30% of the weight of the composite electrolyte.

28. The composite solid electrolyte of claim 27, wherein the carbonate is a lithium-sodium carbonate.

29. The composite solid electrolyte of claim 27, wherein the proton type electrolyte is selected from the group consisting of BYZ, BZCY, and BZCYYb.

30. The composite solid electrolyte of claim 27, wherein the proton type electrolyte is LCaNb.
